(19) United States
(12) Patent Application Publication
(10) Pub. No.: US 2012/0216115 A1
(43) Pub. Date: Aug. 23, 2012

(54) SYSTEM OF AUTOMATED MANAGEMENT OF EVENT INFORMATION

(75) Inventor: Fabrice Lorenceau, Paris (FR)

(73) Assignee: Youfoot Ltd., St. Albans Hertfordshire (GB)

(21) Appl. No.: 13/390,065

(22) PCT Filed: Aug. 5, 2010
(86) PCT No.: PCT/IB10/53543

§ 371 Date: Apr. 27, 2012

(51) Int. Cl. G06F 3/01

(52) U.S. Cl. 715/704

(57) ABSTRACT

A system of automated management concerning event information, comprises:
a downloadable input module (1) to allow a user to input action information by means of a plurality of action templates (11) associated to action types and designed to allow the user to input the predetermined list of parameters associated to action type, and a transmitter (17) adapted to send the inputted action information to a action database as soon as the user has finished to input action information into the selected action template;
a action database (3) receiving the action information and storing each action information into a unique place and associating each action information with the corresponding event;
a commentary generator (5) to transform the action information into a sentence and to send it to a terminal (63, 65) of another user having subscribed to receive action information associated to the event.

### FIELD OF THE INVENTION

The invention relates to the field of system of automated information management concerning an event, the event comprising a plurality of actions.

### BACKGROUND OF THE INVENTION

Though not limited to sport, the present application will use the sport language and needs to exemplify how an automated information management system may acquire, manage and consolidate through statistics and commentaries, information coming from an event such as a competition which may be described as a temporal series of actions.

Thanks to the technological evolution, sports communities have been able to communicate better, faster and in a lot of different ways. At the beginning of the World Wide Web, online sport communities have been created by fans, teams or sport institutions on the model of forums or news web sites. These web sites and forums were built on technologies that were commonly available and lacked specific processes and methods generating dynamic sport statistics, multi-lingual sports commentaries, and media tags for association with media content.

Social networks as “Myspace”, “Facebook” or “Linkedin” surfaced at the beginning of the twenty first century and enabled people connected together to share easily media content. Nevertheless, social networks do not provide the necessary improvements for generating dynamic sport statistics, multi-lingual sport commentaries, and associate them to media content with media tags.

Conventionally, sports statistics and comments are gathered by professional statisticians.

Professional statisticians may generate some data or obtain some data from a database provided by the event organizer or statistical agencies.

As technologies advanced and sports continued to be hugely popular, statistics have become more and more complete, detailed and exhaustive. At the same time, methods for collecting sports statistics have become very sophisticated, employing such devices as video tracking or obtaining evermore rich statistics such as ball possession time, distance covered by the athletes, jump distance, stroke force, distance of the shoot, . . . To obtain this kind of statistics, professionals use specific devices such as radar, RFID chips, multiple cameras and image recognition software, . . .

Due to the professional nature of these statistics and the expensive process to collect them, professional sports commentators and sport statisticians almost never cover lesser important or amateur sport events.

With the rise of the Internet, sports fans have began collecting and sharing statistics on user-generated websites that have multiple data entry points (e.g. wikipedia.org). On these Internet sites, statistics are simply sourced from the work of professional statisticians although users may alter them by comparing or transforming the data provided.

The existing user-generated websites only allow users to type in some statistics gathered from third party sources or type in their comments without any automated treatment of them.

For instance, “Footbo.com” offers on the one hand detailed statistics for “professional” teams that are supplied by Footbo.com and which are created by professional statisticians. On the other hand, Footbo.com provides an “amateur” section where users can solely enter match scores and basic comments by typing them manually.

“Oleole.com” proposes users to comment a soccer match, but users must type in their comments, like in a basic chat or forum. These comments do not generate statistics about the sport event plays.

“Wikipedia.org” functions with user generated statistics, but here again; the statistics must be gathered by the users and typed in.

Sites such as wikipedia.org force users to enter the data as many times as it will appear on different pages and in different languages.

For example, the soccer result “Manchester 3—Everton 1” should appear on the “Match page” as well as the “Manchester page” and “Everton page” or the “English league page”. Accordingly in wikipedia.org, this match result has to be created on these different pages, and also on the different language pages provided. One same statistic has consequently to be created numerous times, to be available on all the relevant information sets displayed on a network, which is inefficient and increases the risk to get incomplete record or contradicting records among the information sets displayed on network.

To sum up, social networks and user-generated websites have been seeking to reach out to the vast communities of sports fans and practitioners and tried to encourage users to generate content—news, videos and sometimes statistics—but lacked the tools to assist sport communities in creating, collecting and organizing sports content such as statistics and commentaries. And particularly:
The existing tools are not dynamic: adding or updating a sport statistic in one information set displayed on network is not echoed on another information set or impacting derived statistics, or, more generally, acting as a collection of logically related records. Such operations have to be done manually time and again. All the more, statistics are not echoed instantaneously. For example the statistics of a player is not echoed in the team's statistics and vice-versa.
The existing tools are not freely available to sport communities to generate sports data for “non-professional” sport events: users typically need to source their statistics from professional sources and cannot cover amateur or lesser important sport events, since professionals do not cover these. Consequently these statistics and comments are not available for the user, and do not exist on the current online sport communities.
The existing tools have multiple entries: On Internet sites like Wikipedia, statistical data has no dependencies and there are multiple data entry possibilities such as a web page about the sport event, pages about the players involved, pages about the teams involved, or page about the competition in which the sport event takes place. This involves, that the user will have to enter the statistics in all entries, if he wants them to appear in the mentioned categories. For example, the user will have to enter the statistics on the team page as well as the player page, or the competition page. Furthermore, if two different users enter different statistics about the same subject in the different data entry possibilities, a lot of confusion arises especially since the data is not correlated or traceable to a single source or entry point. This can quickly introduce untrustworthiness in the data unless data is systematically sourced on each and every page to a professional source. As a result, one of Wikipedia's official English Policy states “the threshold for inclusion in Wikipedia is verifiability, not truth—that is, whether readers are able to check that material added to Wikipedia has already been published by a reliable source, not whether we think it is true” (http://en.wikipedia.org/wiki/Wikipedia:Verifiability).
The existing tools do not provide a commenting process and/or multilingual comments to allow a user to receive comments on a specific events he(she) wants to follow.
The existing tools do not provide multilingual and semi-automated tags to be associated with relevant media content so that media content may be associated easily to a sport event, a player, etc.

### SUMMARY OF THE INVENTION

It would be advantageous to have an automated information management system which solves at least one of the problems explained hereabove.

To better address one or more concerns, in a first aspect of the invention a system of automated information management concerning an event, the event comprising a plurality of actions, comprises a downloadable input module, an action database and a commentary generator, wherein:
the downloadable input module is adapted to allow a user, when downloaded into a terminal of the user, to input action information, the action information comprising an action time, an action type and a list of parameters specific to the action type, the input module comprising:
   a plurality of action templates, each action template being associated to one action type and being designed to allow the user to input the predetermined list of parameters associated to the action type;
   a selection module adapted to allow the user to select among the plurality of action templates, the action template associated to the action type corresponding to the action to input; and
   a chronometer to add the action time to the action information;
   a transmitter adapted to send the inputted action information to a action database as soon as the user has finished to input action information into the selected action template;
the action database comprises:
   a receiver to receive the action information send by the transmitter;
   a storage for storing each action information into a unique place and associated each action information with the corresponding event;
   a trigger associated to the receiver and adapted to activate a commentary generator each time one action information is received; and
the commentary generator comprises:
   a sentence generator adapted to transform the action information into a sentence;
   a multicasting module adapted to send the sentence to a terminal of a follower, the follower being a user having subscribed to receive action information associated to the event.

The system advantageously defines a clear information pathway to obtain reliable and non-contradictory information from non-professionals on which comments may be created and sent to user.

In a particular embodiment,
the input module is adapted to customize the plurality of action templates in accordance to the event before the event beginning;
the storage comprises a versioning module for managing any modification of the action information;
the action database is exclusively accessed by the input module for any action information modification requested by a regular user and the system further comprises a statistical module to generate statistics from the action information stored in the action database;
for any specific event, only one user is allowed to input action information into the system;
the input module comprises a temporary storage connected to the transmitter so that, when the transmission with the action database is cut, action information are stored in the temporary storage and transmitted as soon as the transmission is up;
the sentence generator comprises a storage area containing a set of template sentences, each template sentence being associated to an action type and comprising a variable field, the sentence generator being adapted to select one template sentence associated to the action type of the action information and to fill up the variable field with at least one action parameter. Each template sentence may be also associated to a language, and the follower having defined beforehand a preferred language, the sentence generator is adapted to generate the sentence in the preferred language. And the variable field having a plurality of syntaxes function of the value of the action parameter, the sentence generator may comprise a syntax selector which select the syntax to use based on the number of occurrences of the plurality of syntaxes on the internet;
the multicasting module is adapted to transmit the sentence by using a push mode;
the action information is associated to multimedia content, each multimedia content being automatically tagged by keyword(s) contained in the sentence generated from the associated action information; and/or
the event is defined at least by a place where the event occurs, a date and time of event occurrence and a list of event participants.

In a second aspect of the invention a method of automated information management concerning an event, the event comprising a plurality of actions, comprises:
downloading an input module adapted to allow a user, when downloaded into a terminal of the user, to input action information, the action information comprising an action time, an action type and a list of parameters specific to the action type, the input module comprising:
   a plurality of action templates, each action template being associated to one action type and being designed to allow the user to input the predetermined list of parameters associated to the action type;
   a selection module adapted to allow the user to select among the plurality of action templates, the action template associated to the action type corresponding to the action to input; and
   a chronometer to add the action time to the action information;
receiving the inputted action information to an action database as soon as the user has finished to input action information into the selected action template;
storing each action information into a unique place of the action database and associating each action information with the corresponding event;
transforming the action information into a sentence;
sending the sentence to a terminal of a follower, the follower being a user having subscribed to receive action information associated to the event.

In a particular embodiment, the action database is exclusively accessed by the input module for any action information modification requested by a regular user and the method further comprises a generation of statistics from the action information stored in the action database.

In a third aspect of the invention, a computer-program product is arranged to implement any of the method steps as disclosed here above when loaded and run on computer means.

Depending on the type of information to manage, a particular embodiment may be preferred as easier to adapt or as giving a better result. Aspects of these particular embodiments may be combined or modified as appropriate or desired, however.

### BRIEF DESCRIPTION OF THE DRAWINGS

These and other aspects of the invention will be apparent from and elucidated with reference to the exemplary embodiment described hereafter where:

FIG. 1 is a schematic view of a system of information management according to an embodiment of the invention;

FIG. 2 is a flow chart of use of the system of FIG. 1;

FIG. 3 is a schematic view of a system according to a specific embodiment for sport information management;

FIG. 4 is a flow chart of a data entry process in the system of FIG. 3;

FIG. 5 is an exemplary layout for data entry of player settings in the system of FIG. 3; and

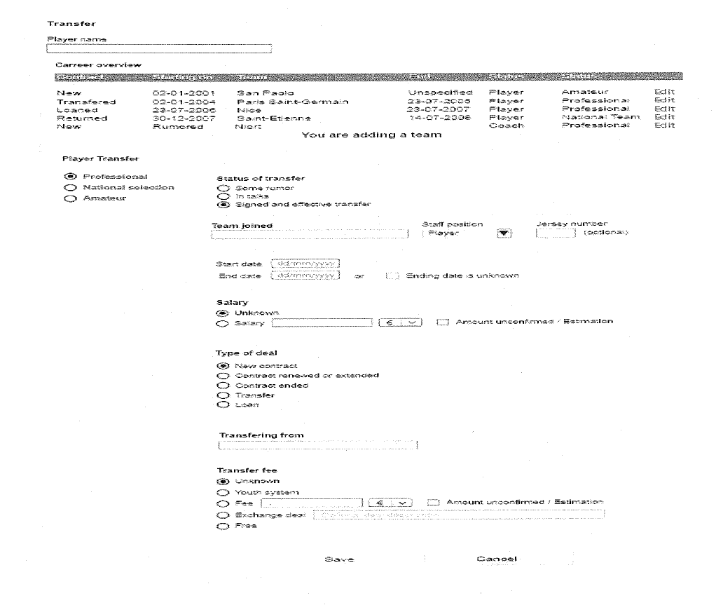

FIG. 6 is an exemplary layout for data entry of components of play in the system of FIG. 3.

### DETAILED DESCRIPTION OF EMBODIMENTS OF THE INVENTION

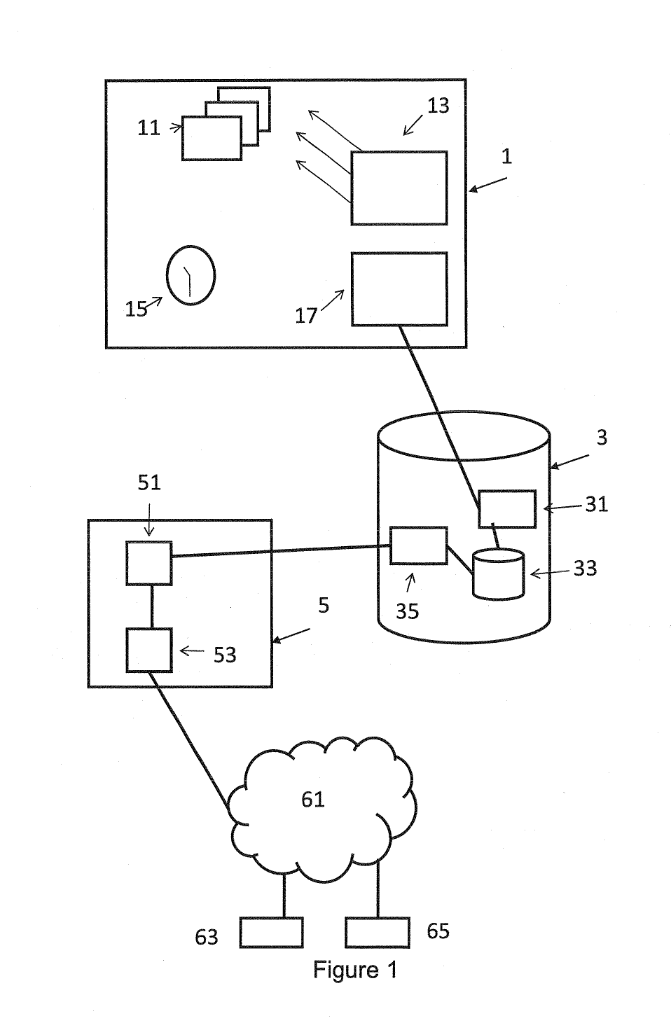

In reference to FIG. 1, a system of automated information management concerning an event, the event comprising a plurality of actions, comprises a downloadable input module 1, an action database 3 and a commentary generator 5.

The downloadable input module 1 allows a user, when downloaded into the user terminal, to input action information, the action information comprising an action time, an action type and a list of parameters specific to the action type. The input module 1 comprises:
a plurality of action templates 11, each action template being associated to one action type and being designed to allow the user to input the predetermined list of parameters associated to the action type;
a selection module 13 allowing the user to select among the plurality of action templates, the action template associated to the action type corresponding to the action to input;
a chronometer 15 to add the action time to the action information; and
a transmitter 17 for sending the inputted action information to a action database as soon as the user has finished to input action information into the selected action template.

The action database 3 comprises:
a receiver 31 to receive the action information send by the transmitter;
a storage 33 for storing each action information into a unique place and associated each action information with the corresponding event;
a trigger 35 associated to the receiver and adapted to activate the commentary generator 5 each time one action information is received.

The commentary generator 5 comprises:
a sentence generator 51 for transforming the action information into a sentence;
a multicasting module 53 for sending the sentence to a terminal 63, 65 of a follower. The follower is a user having subscribed to receive action information associated to the event.

The system is typically based on Internet technologies and particularly web protocols.

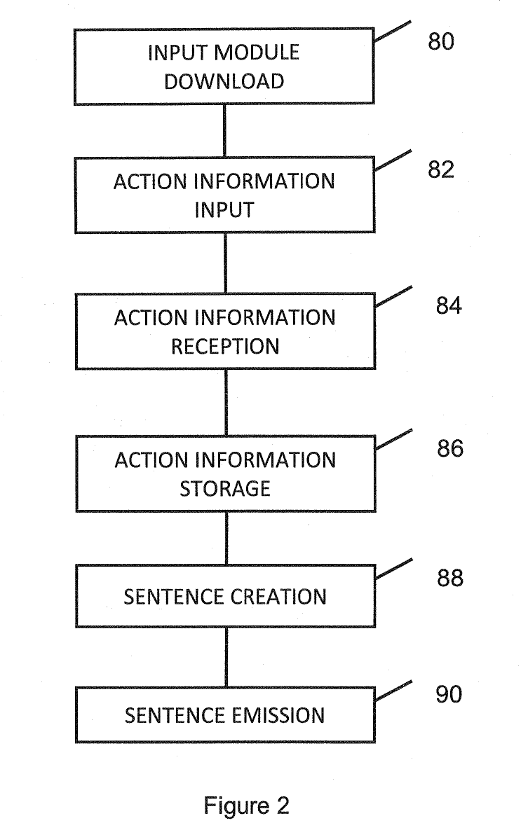

The system use for managing the information of an event follows typically the method of, FIG. 2:
downloading, step 80, the input module 1 into the terminal user;
inputting, step 82, action information by the user by means of the input module 1, and particularly one input template related to the action to describe;
receiving, step 84, the inputted action information to the action database 3 as soon as the user has finished to input action information into the selected action template;
storing, step 86, each action information into a unique place of the action database and associating each action information with the corresponding event;
transforming, step 88, the action information into a sentence;
sending, step 90, the sentence to a terminal of a follower, the follower being a user having subscribed to receive action information associated to the event.

Based on this overview of the system and its use, now will be described a specific embodiment focused on a system to allow non-professionals to easily generate multi-lingual sport commentaries and dynamic statistics and associate them by the mean of pre-generated multi-lingual keywords (so called “media tags”), to any image, video, text (so called “media content”) that a sport community may upload on an user-generated website.

It allows a single user to describe all major plays and characteristics Of a sport event.

It can generate hundreds of dynamic statistics as well as commentaries in several natural languages, and also media tags available for association to any media content that maybe uploaded illustrating a sport event or one of its plays.

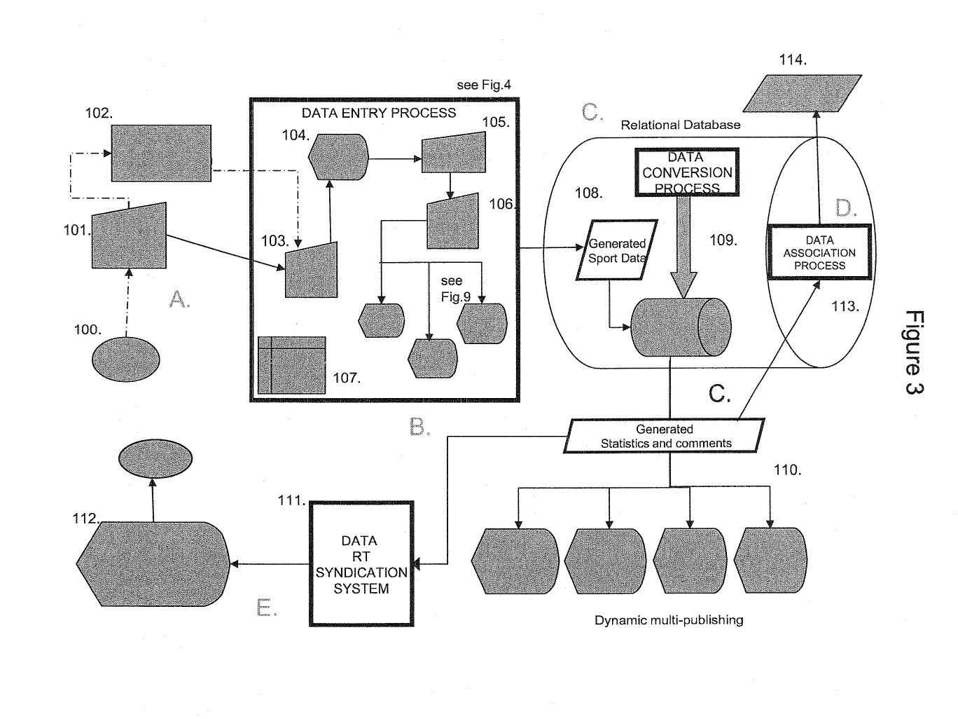

The system is composed of the following items, FIG. 3: the data entry process 103, 104, 105, 106, 107, the RT safety method 107, the data conversion process 109, the Article disambiguation process, the Dynamic publishing method 110, the data RT syndication system 111 and the data association process 113.

I. Data Entry Process

The data entry process B of FIG. 3 enables the user of a sport community to describe precisely a sport event—in real-time or not—without need of particular computer or statisticians skills, by simple clicking or selecting 103, 106 first on graphic representations of components of sport event 104 (such as players, teams, venue, weather . . . ), and then, after having started the sport event 105, on graphic representations of components of play 106 (Goal, arbitration decision, type of shoot, strength of shoot . . . ).

Each component of sport event and each component of play available within the sport is represented on a graphical user interface, or action template, enabling the user to choose the relevant graphical user interface for each characteristic and each play of the sport event he wants to describe and comment 902.

Thus, clicks and selections of the user on the graphical user interfaces of the components of play and components of sport event provide the process with the relevant user queries for describing a sport event and for generating statistics and comments.

According to the process, the user queries are then collected using a scripting language (e.g. Actionscript, Javascript) or a framework of applications (e.g. Adobe Flex associated to Adobe Air) which sends the user queries to a collection of logically related records (e.g. database or structured data interchange mark-up language such as JSON or XML).

The collected user queries are time-stamped for purposes of versioning, allowing users such as community referees, i.e. users among the online sports community with administrative privileges (These users are selected upon diverse criteria such as volunteering, quality of past contributions, involvement in the community, number of friends, etc.), to revert back to previous versions of comments and statistics.

For faster access such data may also be replicated (e.g. in a slave-database or in a memory caching system such as a memcache) C of FIG. 3.

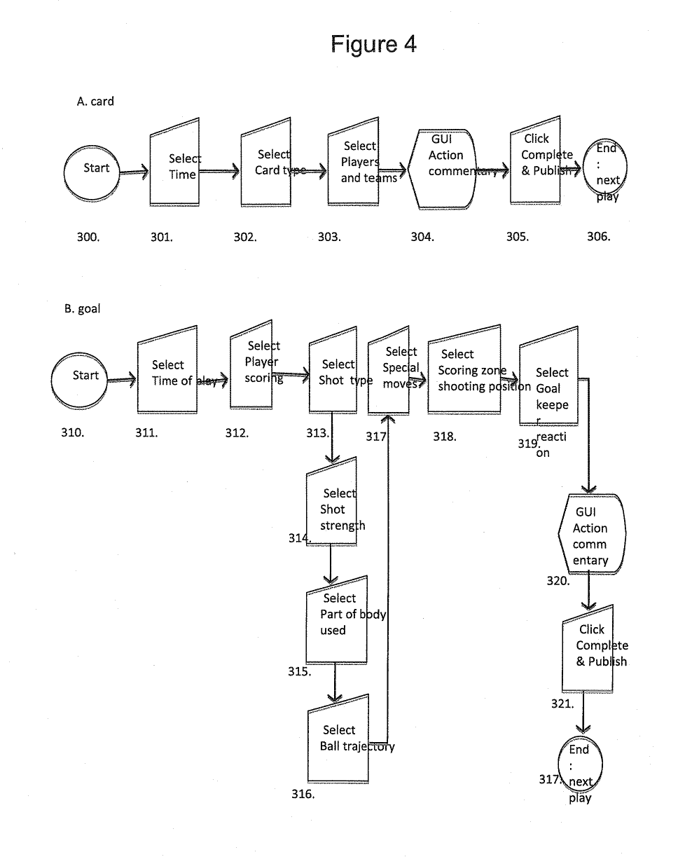

Furthermore, the data entry process has the following specific characteristics. FIG. 4:
The graphical user interfaces representing the components of sport event and components of play are determined with help of the “Five Ws and one H” method.

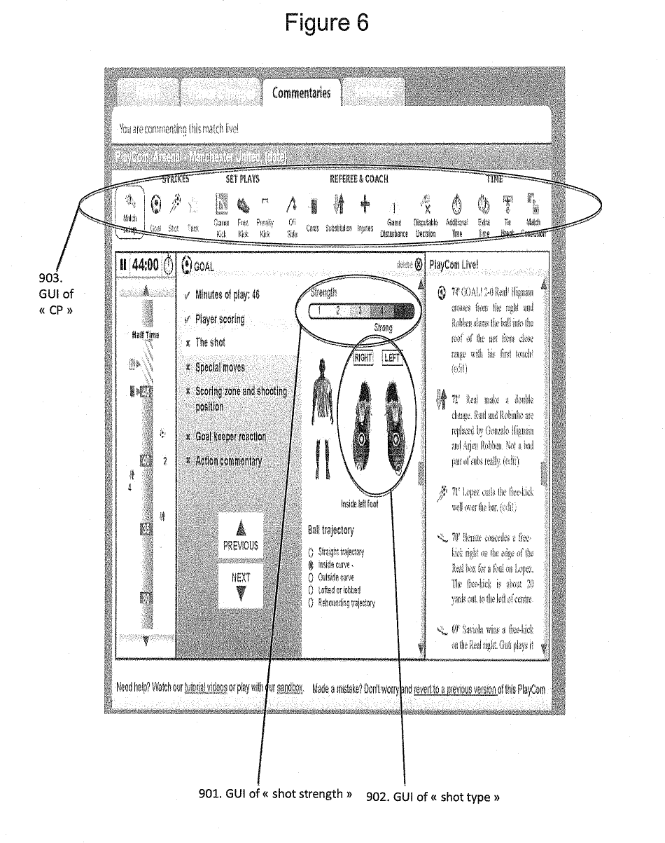

Any sport can be broken down in components of sport, plays and components of play and event using the journalistic information gathering method of the “Who What When Where Why and How”, also known as the “Five Ws and one H”. This information gathering method may be used to systematize the graphical representations of the components of play and components of sport event in order to enable the best description possible (An example is given FIG. 6).

The graphic representations of the components of play and components of sport event are fitting to the “Who What When Where Why and How” of almost any sport event and plays of a given sport. Consequently, one skilled in journalism could easily determine the needed graphical representations of components of play and components of sport event to enable the best description possible of a sport event and its plays.

As the “How” specifies each “Ws”, this method may be used as follows:
The “what and how”:

With regard to the components of plays: a “goal” in soccer, answers to the “what”. In the case of a “goal” the user will, using the data entry process, be able to specify elements of the “how”, as the “strength of the shot” 313, “ball trajectory” 314, 315 or “goalkeeper reaction” 316.

With regard to the components of sport event: the “what” permits to define if the sport event is a national competition, an international competition, a non competitive event . . . The “how” enables to define at which competition the sport event belongs to or at which competition stage.
The “who and how”:

With regard to the components of plays: “name of the player” 303 or “name of the team” responds generally to the “who”. The “how”, explains how the player or the team is involved in the play: who performed an action, who suffered from an action, etc.

With regard to the components of sport event: the “who” may describe the teams or athletes participating to the sport event and the “how” describes the participation of the athlete regarding to the team (e.g. formation, tactics or position) or regarding to the sport event (e.g. category of the athlete, the favorite athlete, the record holder).
The “when and how”:

With regard to the components of plays: the “when” typically consists in situating the play in relation to the periods and timer of a sport event when the sport event is timed or limited in its duration 301, 311. The “how” could be the type of period, the play occurs (e.g. tie break, sudden death, last lap, final round etc . . . )

With regard to the components of sport event: the “when” generally defines the start time, the end time or the duration of the sport event. The “how” could be the period of the day when the sport event takes place (e.g. night, afternoon, morning).
The “where and how”:

With regard to the components of plays: the “where” may describe the position on the venue where the play occurred (e.g. yardage, the green, goal area, starting line . . . ). The “how” could be the conditions of the place (e.g. the slope of the golf field, the distance from the finish, with east wind, inside of the curve).

With regard to the components of sport event: the “where” typically describes the venue of a sport event (Old Trafford, Stade de France, Olympia Stadion . . . ). The “how” may be related to the weather conditions of the sport event (e.g. dry soccer field, rainy golf yard, storm on the boat route . . . ).
The “why and how”:

The “why and how” is seldom relevant since the athletes or players have a very specific intend which is typically obvious in the context of the sport event itself: a goal to reach, a time to beat, a height to reach, an adversary to defeat . . . It may occasionally be used for instance to describe an error in judgment from the referee or the athlete of the sport event, or to explain why a special resolution occurred in a sport event (e.g. team disqualified because its fans invaded the field, or athletes disqualified because of doping).
The data entry process by simple clicking and selecting

The data entry process offers sport fans the possibility to describe easily a sport event and to generate effortlessly complex statistics and detailed sport comments in natural language by simple clicking and selecting.

The user doesn't have to type in the characteristics of each play of the sport event nor to know statistics or to type in text comments. He will generate statistics and comments by his simple clicking and selecting on the graphical user interfaces representing components of sport event and components of play.

For example, FIG. 6, a shaded bar divided in five squares could be used to represent the force of a shoot, and enable the user to select by simple click on one of the five squares the right intensity of the shoot 901, which, combined with the selection he may do as well on a graphic representation of the goal, and on a graphic representation of the field, generate the comment and the statistics needed to describe precisely the shoot.

Other example: a graphic representation of shoes with marked points could be used to enter very easily the type of soccer shoot. The user clicks on the points located on the shoes to indicate with which foot and which part of it the player shot the ball. The commentary differs then depending on the choice the user has made 902.

Applied to golf, a graphic representation of the map of the golf field can enable the user to click on the places where the golf ball stopped. Such graphical user interface can be used to collect data on the number of shoots, the distance per swing of the golfer, the placement of the golf ball on the field . . .
The data entry process uses one single data entry point, but enables to publish on multiple information sets displayed on network 103, 104, 105, 106, 110.

The possibilities of data entry are limited. A single data entry point is important to prevent data conflicts from multiple sources and multiple users. It makes impossible to a user to create several times the same sport event.

Excepting the subsequent setting of the teams and players needed for the commenting of the sport event, the data entry process disposes of one single data entry point: “the sport event”.

Having a single data entry point gives users a clear understanding of the source and trustworthiness of the data. Indeed, a system employing a single data entry point makes it easier for a sport community to identify the cause of any erroneous data and to correct the data since all statistics and comments are related to a sport event.

All graphical representations of components of sport event and component of play are linked to the sport event. The user query related to a particular sport event cannot be entered in another data entry point, than the sport event it is related to. Consequently, all user queries are centralized in the sport event tables of a relational database C, FIG. 3.

Nevertheless, the generated comments and statistics will be published on multiple information sets displayed on network as for example “player page”, “team page” or “competition page” 110 and filters in a scripting language (e.g. PHP, Javascript, etc.) are used to show the relevant generated comments and statistics on such various specific information sets.
The data entry process uses a step-by-step method 106

The data entry process forces the user to comment step-by-step a sport event. That means each play is commented one after another by using the graphic user interface of the relevant component of play. Because it enables the user to focus on each play, the step-by-step method maximizes the chances of professional results. It is often said, that professional statisticians and commentators comment sport events <<play-by-play>>. This step-by-step method is the transposition and adaptation of such oral practice of said “play-by-play commentators”.
The data entry process length varies function of the usual time off periods of the sport.

If the user comments a sport event in real-time, it is very important, that the data entry process neither last too long in order to stay usable, nor last too short in order to get for one single play complete and accurate data (FIG. 3).

To avoid this problem, on a case-by-case basis, the data entry process and the number of components of play available for description are broadened or restricted in order to make it feasible for the user to follow a sport event on television, radio or at the sport venue itself, and comment it by using the system in real-time.

For example, if we apply the system to soccer, the data entry process for a yellow card is shorter than the one for a goal, because there is on a soccer match a longer time-off period after a goal making it possible to use more time for commenting the match, FIG. 4. After a player has been booked, the match may continue quickly, which is not the case after a goal. A very short data entry process for yellow and red cards is necessary to enable a quick comment.

For basketball, shooting and scoring are both not followed by long time off periods, so that the data entry process has to be short in both cases.

For American football or golf, after every play you have a time off period, so that on all actions you can have a longer data entry process.

Optionally, a timer may assist the user to select the moment at which a particular play occurs. The user only has to start the timer at the beginning of each period of the sport event.
The data entry process is complemented by a RT safety method 107

Due to the eventuality of commenting a sport event in real-time and the untrustworthiness of some network connections the data entry process includes also a real-time safety method in case the commentator's network connection fails or becomes intermittent.

When the user do user queries using the data entry process, all generated sport data is saved on the client side, (e.g. using either through cookies, or an SQL-lite database as available in HTML 5 or the Google Gears plug-in, or the internal memory of a rich internet application as available for instance using the Adobe Flex framework) and, once the network connection is established again, the generated sport data is sent in real-time to the relational database in order to proceed to the data conversion process described below.
The data entry process utilizes a dynamic publishing method.

Due to the importance of making immediately available the generated statistics and comments to spectators of a live sport event, a method for pushing the generated sport data in real-time to the data conversion process is established in order to reflect the changes implied by new user queries on the published generated statistics and comments.

To achieve this operation, the generated sport data is immediately converted in generated statistics and comments which are stored in a server using instant messaging technologies (e.g. XMPP protocols and Jabber server). This server pushes any fresh data to any and all users connected without having the users to “refresh”.

For example, applied to soccer, should a player score a goal, the score of the match will instantaneously change and be reflected in real time in the network page of the match without having to manually “refresh” the page. Additionally statistics of the player, statistics of the team or even statistics regarding the best scoring players of the competition may become immediately available should generated statistics and comments be made available for the users in a specific “push” server (e.g Jabber server).

This characteristic of the data entry process thus enables the publishing in real time of the generated statistics and comments D of FIG. 3.

II—Data Conversion Process

As the user is going through the data entry process, the collected generated sport data is converted into dynamic statistics and multilingual comments (so called generated statistics and comments) with help of the data conversion process C of FIG. 3.

II.1—The Main Process

The data conversion process uses all of the commentator's user queries from the data entry process describing the sport event and its plays (the generated sport data) 108 to generate automatically statistics and comments in multiple natural languages (the generated statistics and comments) 110. The data conversion process is based on a scripting language (e.g. PHP) to set a conditional data structure built on the described components of sport event and components of play.

A conditional structure is preset whereby each possible user query corresponds to several fragments of sentence of the same meaning. The process chooses randomly one of the fragments of sentence for each user query. Each fragment of sentence is also available in different languages, to provide a multilingual comment. The final sentence in natural language comments precisely the described play and fits to all user queries related to it.

All the generated sport data collected—the user queries describing components of sport event (e.g. teams, players, weather, venue . . . ) and components of play (e.g. time of the action in the sport event, players involved, distance of the shot, force of the shot . . . )—has an effect on the generated statistics and comments.

Previous as well as current user queries have an effect on the generated statistics and comments. For instance, in a soccer match, the first goal for a team will have a different comment than the third. In that case, the time of the goal will also have an effect. A goal shot in the last minute of the match, that would change the outcome of the match, will have a different comment than a goal shot in the first minutes of the match.

There can be more than one possible fragment of sentence per variable; in this case the fragment of sentence can be selected randomly among equal options to allow more variations in the phrasing of a comment having the same variables.

Once the user has gone through the data entry process of one play, the process aggregates the fragments of sentences. The final result gives to the user a multilingual comment fitting with the user queries he made. By this mean, the generated sport data is converted in the appropriate comments.

To exemplify, a complete conversion is shown hereunder:

1. The first step typically presents the “Who” and “What”. For soccer, the yellow and red card is a component of play. If a player gets a card, one of the following random fragments of sentence could first be selected in the process, whereas the variable between curly brackets is determined by the user queries:

{name of player who committed the foul} makes a foul on {player who was fouled} . . .

Or

Foul by {name of player who committed the foul} on {player who was fouled} . . .

2. The second step may react to the “When”, “How” and specify eventually the “What”, “Why” and “Where”. In our example, the time of the play and the type of sanction that the referee gives a player (a yellow card, a second yellow card or a red card) are taken into account. To carry on with the previous example, the following variables may enter in consideration by the data conversion process to finish this particular commentary:

If a card is given in the 35 first minutes of the match:
If First Yellow card 402
   and is going in the book with a yellow card. That's no way to start a match.

Or

and gets a yellow card. He will have to be careful from now on.
If Second Yellow card 403
   who gets a second yellow which means red card! The match will be much harder for {booked player's team} from now on.

Or
and it's a red card after this second yellow! That'll be hard to get over.
If Red card 404
   who gets a red card! The match will be much harder for {booked player's team} from now on.

Or
and red card ! That'll be hard to get over.

If a card is given after 35 minutes of playing:
If First Yellow card 405
   For which the referee gives him a yellow card
   Or
   And that gets him a yellow card
If Second Yellow card 406
   who gets a second yellow, which means it's a red card!
   Or
   and the referee shows the red card! He's been {{booked}} already.
If Red card 407
   who gets a red card!
   Or
   and the referee shows the red card!

3. On a third step, the final commentary is published. For example, fora second Yellow card for Puyol after a foul on Casillas on the 33rd minute of a soccer game between the Real Madrid and Barcelona, the result would be randomly:

“Puyol makes a foul on Casillas and gets a second yellow, which means red card! The match will be much harder for Barcelona from now on.”

Or

“Foul by Puyol on Casillas who gets a second yellow, which means red card! The match will be much harder for Barcelona from now on”

Or

“Foul by Puyol on Casillas and it's a red card after this second yellow! That'll be hard to get over.”

Or

“Puyol makes a foul on Casillas and it's a red card after this second yellow! That'll be hard to get over.”

Since each sentence fragment exists also in multiple languages 408, the generated statistics and comments are presented to the commentator in his language of preference but are also automatically available in multiple languages for the other users.

4. On a fourth step, the generated statistics and comments are saved “as published” for purposes of versioning on the client-side.

Furthermore, if a play is commented after others already commented plays which are chronologically happening before in the sport event, the process regenerates the past comments, taking into account the new commented play.

II.2—Article Disambiguation Process

Moreover, in some cases, such as when the variables of the data conversion process are names (such as team names, play names or venue names), and depending on languages being generated, the article preceding the variable may vary.

Then a process is applied based on a statistical method to disambiguate between all possible articles. A server-side application launches a series of queries to one or more general, public and reputable search engines such as the “Google” search engine with help of the appropriate API or script language. Comparing the number of search results found for each possible “article” queried provides a fairly reliable method to select the article appropriate to use in front of the name.

For instance, using the Article disambiguation process, the data conversion process may generate the following French commentary:

“But de {Team Name}” (in English “Goal from {Team name}”)

The choice of the article “de” depends on the variable {Team Name} In other words, depending on the team name the article preceding the variable {team name} may be: de, du, d', de l', de la.

For instance:

“But de l'Equipe de France”

“But du Paris Saint-Germain”

“But de la Squadra Azzura”

“But de Toulouse”

“But d'Angers”

In these cases, the Article disambiguation process uses the Internet as a whole corpus of text to see statistically which the most likely article to use is. A popular search engine is used to query into this corpus of text and compare the number of results for each exact query. We may obtain for instance:

“du Paris Saint-Germain”→126 000 results

“de Paris Saint-Germain”→51 000 results

“de la Paris Saint-Germain”→1 result

“d'Paris Saint-Germain”→4 results

“de l'Paris Saint-Germain”→No results

The article disambiguation process selects the article, which was found to be the most used statistically across the Network.

III—The Data RT Syndication System

Once the data conversion process is completed for all generated statistics and comments deemed critical to be available instantaneously, these statistics and comments are made accessible to the users in real-time—or at least dynamically—and in a readable way.

The information is stored in a specific server providing the data “RT” (real-time) syndication system which centralizes the generated statistics and comments E of FIG. 3.

Thanks to the data RT syndication system, the generated comments and statistics are collected onto a “push” server (e.g. Jabber server) using protocols (e.g. XMPP protocol and its Pubsub Extension XEP 060) and published instantaneously to any users present on the network and to various information sets displayed on the network.

Some filters may be applied, for selecting the relevant information the sport community manager wants to publish.

IV—The Data Association Process

The generated statistics and comments are associated to media tags identified as such by a special mark-up. These media tags are suggested to the user, when he uploads media content, for associating it to the generated statistics and comments and the sport event and plays, they refer to. The data association process permits the generated statistics and comments to be linked to the relevant images, videos, and texts, the user may have uploaded D of FIG. 3.

Important keywords are identified in the scripting language used for the data conversion process,—including the variables—which may be used for connecting media content to a particular play (and thus his comment), a sport event, a player, a team, to all relevant information which has been previously collected from the users or set by the sport community manager.

When the user wants to upload media content, he will be asked to enter tags of the sport event the content shall be linked to, and eventually other keywords. A graphic user interface is conceived for forcing the user to first connect the media content he wants to upload to a sport event. Then, he offered the possibility to the user to choose the precise play of the sport event the media content shall be linked to, providing suggestions of media tags by the mean of a predictive text technology searching for the previously identified keywords.

Technically, a filter in scripting language (e.g. javascript) is associated with a regular expression script permitting to track the identified keywords in the commentary of the sport event (e.g. php) and finally suggests to the user relevant tags.

For example, in our previous example where a soccer player did a foul and gets a card, the script may be: “name of player who committed the foul” makes a ((foul)) on “player who was fouled” 401. The word “foul” is selected to be a keyword, in order to propose to a user who would upload Media content related to that play of the sport event, to connect it to the commented play. The variables of the scripting language, and more generally of the settings of the sport event such as “name of the player” are also identified as keywords.

This data association process enables to link precisely media content uploaded by the user to some available relevant information.

The method may be implemented by a computer program product that is able to implement any of the method steps as described above when loaded and run on computer means. The computer program may be stored/distributed on a suitable medium supplied together with or as a part of other hardware, but may also be distributed in other forms, such as via the Internet or other wired or wireless telecommunication systems.

An integrated circuit may be arranged to perform any of the method steps in accordance with the disclosed embodiments.

While the invention has been illustrated and described in details in the drawings and foregoing description, such illustration and description are to be considered illustrative or exemplary and not restrictive; the invention is not limited to the disclosed embodiment.

Particularly, the enclosed embodiment are not limited to the management of sport information but may be used in any field where an event can be described as a time series of elementary actions, the elementary actions belonging to a limited list of possible actions and being qualified by a limited list of parameters.

Other variations to the disclosed embodiments can be understood and effected by those skilled on the art in practicing the claimed invention, from a study of the drawings, the disclosure and the appended claims. In the claims, the word “comprising” does not exclude other elements and the indefinite article “a” or “an” does not exclude a plurality.

1. System of automated information management concerning an event, said event comprising a plurality of actions, said system comprising a downloadable input module (1), an action database (3) and a commentary generator (5), wherein:
the downloadable input module (1) is adapted to allow a user, when downloaded into a terminal of said user, to input action information, said action information comprising an action time, an action type and a list of parameters specific to said action type, said input module comprising:
a plurality of action templates (11), each action template being associated to one action type and being designed to allow the user to input the predetermined list of parameters associated to said action type;
a selection module (13) adapted to allow said user to select among the plurality of action templates, the action template associated to the action type corresponding to the action to input;
a chronometer (15) to add the action time to said action information; and
a transmitter (17) adapted to send the inputted action information to a action database as soon as the user has finished to input action information into the selected action template;
the action database (3) comprises:
a receiver (31) to receive the action information send by the transmitter;
a storage (33) for storing each action information into a unique place and associated each action information with the corresponding event;
a trigger (35) associated to the receiver and adapted to activate a commentary generator each time one action information is received; and
the commentary generator (5) comprises:
a sentence generator (51) adapted to transform the action information into a sentence;
a multicasting module (53) adapted to send said sentence to a terminal (63, 65) of a follower, said follower being a user having subscribed to receive action information associated to the event.

2. System according to claim 1, wherein the input module is adapted to customize the plurality of action templates in accordance to the event before the event beginning.

3. System according to claim 1, wherein the storage comprises a versioning module for managing any modification of said action information.

4. System according to claim 1, wherein the action database is exclusively accessed by the input module for any action information modification requested by a regular user and said system further comprises a statistical module to generate statistics from the action information stored in the action database.

5. System according to claim 1, wherein for any specific event, only one user is allowed to input action information into the system.

6. System according to claim 1, wherein the input module comprises a temporary storage connected to the transmitter so that, when the transmission with the action database is cut, action information are stored in said temporary storage and transmitted as soon as the transmission is up.

7. System according to claim 1, wherein the sentence generator comprises a storage area containing a set of template sentences, each template sentence being associated to an action type and comprising a variable field, said sentence generator being adapted to select one template sentence associated to the action type of the action information and to fill up the variable field with at least one action parameter.

8. System according to claim 7, wherein each template sentence is also associated to a language, and the follower having defined beforehand a preferred language, the sentence generator is adapted to generate the sentence in the preferred language.

9. System according to claim 7, wherein the variable field having a plurality of syntaxes function of the value of the action parameter, the sentence generator comprises a syntax selector which select the syntax to use based on the number of occurrences of the plurality of syntaxes on the internet.

10. System according to claim 1, wherein the multicasting module is adapted to transmit said sentence by using a push mode.

11. System according to claim 1, wherein the action information is associated to multimedia content, each multimedia content being automatically tagged by keyword(s) contained in the sentence generated from the associated action information.

12. System according to claim 1, wherein the event is defined at least by a place where the event occurs, a date and time of event occurrence and a list of event participants.

13. Method of automated information management concerning an event, said event comprising a plurality of actions, said method comprising:
downloading (80) an input module adapted to allow a user, when downloaded into a terminal of said user, to input action information, said action information comprising an action time, an action type and a list of parameters specific to said action type, said input module comprising:
a plurality of action templates, each action template being associated to one action type and being designed to allow the user to input the predetermined list of parameters associated to said action type;
a selection module adapted to allow said user to select among the plurality of action templates, the action template associated to the action type corresponding to the action to input; and
a chronometer to add the action time to said action information;
receiving (84) the inputted action information to an action database as soon as the user has finished to input action information into the selected action template;
storing (86) each action information into a unique place of said action database and associating each action information with the corresponding event;
transforming (88) the action information into a sentence;
sending (90) said sentence to a terminal of a follower, said follower being a user having subscribed to receive action information associated to the event.

14. Method according to claim 13, wherein the action database is exclusively accessed by the input module for any action information modification requested by a regular user and said method further comprises a generation of statistics from the action information stored in the action database.

15. A computer-program product arranged to implement any of the method steps as described in claim 13 when loaded and run on computer means.

16. A computer-program product arranged to implement any of the method steps as described in claim 14 when loaded and run on computer means.
